(19) United States
(12) Patent Application Publication
(10) Pub. No.: US 2013/0031261 A1
(43) Pub. Date: Jan. 31, 2013

(54) PAIRING A DEVICE BASED ON A VISUAL CODE

(71) Applicant: Bradley Neal Suggs, Sunnyvale, CA (US)

(72) Inventor: Bradley Neal Suggs, Sunnyvale, CA (US)

(21) Appl. No.: 13/194,267

(22) Filed: Jul. 29, 2011

(51) Int. Cl. G06F 15/16

(52) U.S. Cl. 709/228

(57) ABSTRACT

A pairing with a computing device may be based on a visual code. A pairing, associated with application input, may be established between a first control module associated with a responding computing device and a second control module associated with the computing device.

### BACKGROUND

Establishing network discovery and security for communication between computing devices such as PCs and mobile devices has typically been accomplished through a cumbersome and technically challenging user experience of entering addresses and security credentials. Resources to be accessed may be spread across multiple independent devices causing difficulty in organizing, searching, or browsing the resources.

### BRIEF DESCRIPTION OF THE DRAWINGS/FIGURES

FIG. 1 is a block diagram of a computing device according to an example.

FIG. 2 is a block diagram of a computing device according to an example.

FIG. 3 is a block diagram of a responding computing device according to an example.

FIG. 4 is a block diagram of a computing device according to an example.

FIG. 5 is a block diagram of computing devices and responding computing devices according to an example.

FIG. 6 is a block diagram of a computing device and a responding computing device according to an example.

FIG. 7 is a flow chart based on establishing a communication pairing between a computing device and a responding computing device based on a visual code according to an example.

The present examples will now be described with reference to the accompanying drawings. In the drawings, like reference numbers may indicate identical or functionally similar elements.

### DETAILED DESCRIPTION

An example interaction framework enables communications between devices by initiating the transfer of address and security information through a visual sideband channel, by encoding the information in a datagram/visual code that is displayed and viewed by participating devices. A user may pair devices and access resources such as services and media, e.g., between multiple mobile devices and multiple Personal Computers (PCs), by simply launching an application and pointing one device at another, without cumbersome network configuration or tedious determination of identities of networked devices associated with particular desirable resources. If a device is not configured to establish, initiate, and/or participate in a resource access connection, a control module may be downloaded corresponding to that device, e.g., from an app store, and sent to the device to enable it to connect and enable interaction with its resources. Examples enable control of media associated with the Internet and with local sources, including digitized media and physical media (such as remotely controlling playback of a Digital Versatile Disc (DVD) accessed by a set-top DVD player). Resources may be accessed within the example framework based on a media-centric, application-centric, or device-centric approach independently of the physical configuration of the devices and without requiring technical configuration knowledge. The framework may allow creation and customization of characteristics such as playlists or other informational organization and interaction associated with an entire collection of resources across multiple devices, enabling browsing, accessing, searching, or otherwise interacting with resources globally across multiple devices/resources without requiring independent searches or browsing of each specific device or resource.

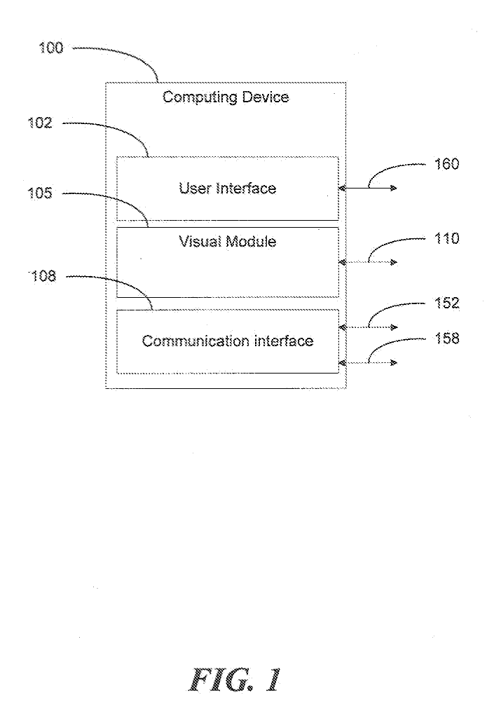

FIG. 1 is a block diagram of a computing device 100 according to an example. Requesting computing device 100 may be a mobile device such as a smartphone, netbook, notebook, and/or tablet, and may include a user interface 102, a visual module 105 including a sensor and/or display, and a communication interface 108. In one embodiment, the computing device 100 may act as a requesting computing device. In another embodiment, the computing device 100 can act as a responding computing device. The user interface 102 may be associated with application input 160. The visual module 105 may be associated with a visual code 110. The communication interface 102 may be a hardware component utilized by the computing device 100 to communicate with other devices. In an embodiment, the communication interface 102 can include a wired or wireless network interface component. In other embodiments, the communication interface can be associated with Bluetooth, infrared, terrestrial cellular networking, satellite networking, near-field communication (NFC), and other forms of communication. The communication interface 108 may be associated with a communication pairing 152 and/or an application function pairing 158. The computing device 100 may pair with other devices based on the visual code 110. Application input 160 may be transmitted to interact with resources/media/services of other devices.

The visual module 105 may include a sensor and/or a display. In one embodiment, the sensor may sense a visual code 110 from a responding computing device. The sensor of visual module 105 may include a camera, video sensor, light sensor, proximity sensor, accelerometer, gyroscope, compass, microphone, and other sensors. In another embodiment, a display of visual module 105 may generate the visual code 110 to be sensed by a responding computing device. The visual code 110 may be a barcode, including one- and two-dimensional barcodes such as Quick Response (QR) codes, datagrams, steganography, numbers, characters, symbols, or other implementations to use a visual channel for communication. The visual code 110 may include information that identifies a device and/or enables communication over the network, such as a network address (Internet Protocol (IP) address), network port, security credentials (password, cryptographic keys, security certificates), and so on.

The visual code 110 may be dynamically generated, including time-sensitive information such as a Dynamic Host Configuration Protocol (DHCP) assigned network address and/or a connection password having an expiration date. The visual code 110 may also include a pointer and/or shortcut to additional information, such as a website address that may be used to access additional information associated with the visual code 110. The visual code 110 may encode additional information, such as executable instructions and/or software modules to instruct a device to configure itself for pairing. The visual code 110 may be generated/encoded/decoded based on functionality provided by JavaScript and/or ZXing (zebra crossing) libraries for visual code generating/encoding/decoding.

Computing device 100 may communicate with other devices via visual or other non-networked communication channels using at least one visual module 105. Communication pairing 152 may be established based on a visual code 110 even if computing device 100 lacks either a sensor or display associated with visual module 105, because the visual code 110 may be passed between a responding computing device and the computing device 100 in either direction depending on which device is capable of generating and/or sensing the visual code 110.

The computing device 100 may sense visual code 110 from a responding computing device in response to a determination that the responding computing device lacks a camera. The computing device 100 may display a visual code 110 to a responding computing device in response to a determination that the responding computing device lacks a display or otherwise fails to provide a visual code 110. Computing device 100 may enable a selection of whether to sense and/or display the visual code 110, and may try sensing and/or displaying in series or simultaneously. In alternate examples, the computing device 100 may therefore include the a sensor and/or display in visual module 105.

The computing device 100 may configure user interface 102 to provide an option for initiating a pairing. For example, user interface 102 may provide a prompt to request a pairing or simply begin the request upon the user interface 102 being shown. Communication interface 108 may send and/or broadcast a request to other devices, such as a responding computing device. The request may instruct a responding computing device to generate visual code 110, and/or may instruct a responding computing device to sense a visual code 110 that may be generated by computing device 100. A device to generate the visual code 110 may be chosen based on a screen size. For example, the computing device 100 may generate request a responding computing device to generate visual code 110 on a large-screen television display. Thus, the large visual code 110 may be sensed by the computing device 100 from a greater distance, compared to the computing device 100 displaying the visual code 110 on its comparatively smaller screen to be sensed by the television (e.g., details of the larger image of a screen of a large television, compared to a smaller mobile device, may be discerned from a greater distance due to the greater image size). However, sensors may enable visual sensing from various distances regardless of screen size, although relative larger screen/image sizes may enable relatively greater success at resolving image details for a given distance.

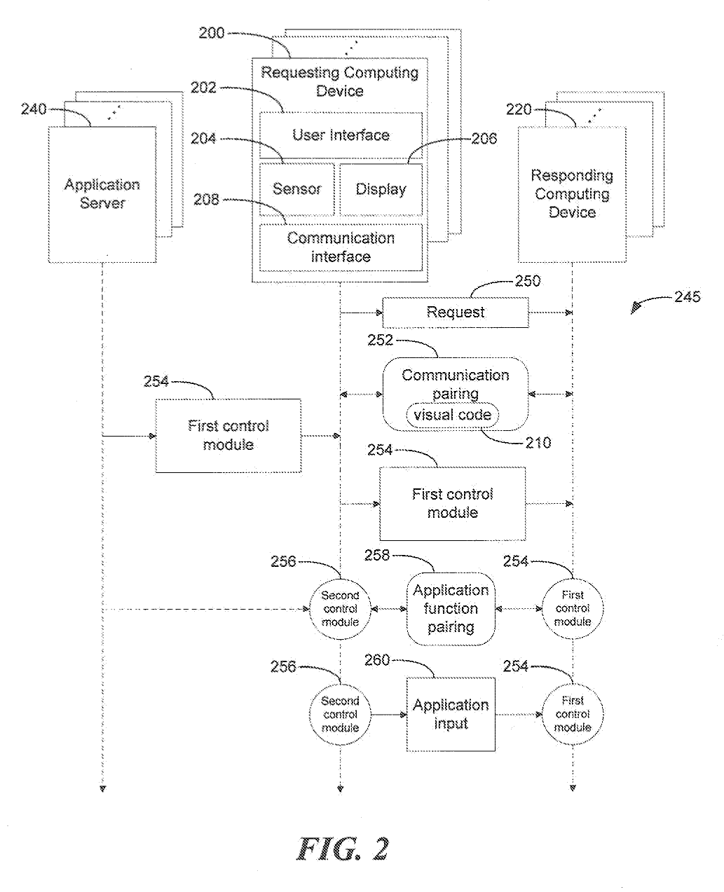

FIG. 2 is a block diagram of a requesting computing device 200 according to an example. The requesting computing device 200 may pair 245 with the responding computing device 220 to access services and resources of the responding computing device 220. Control modules may be retrieved from an application server 240. The requesting computing device 200, responding communication device 220, and application server 240 may be associated with a network such as a Wide Area Network (WAN), Local Area Network (LAN), Personal Area Network (PAN), Wireless Local Area Network (WLAN), Wi-Fi 802.11b/g/n, ad-hoc network, or other network.

Communication pairing 252 based on visual code 210 may be achieved independently of a network connection, through a visual sideband channel (i.e., using a sensor and display to transmit and receive an optical signal transmitted through the air by line of sight between the display and sensor). Accordingly, a user may establish the communication pairing 252 without knowledge of network or configuration settings or set up. Communication pairing 252 based on a visual code 210 is intuitive and elegant, allowing selective pairing based on generating visual codes 210 selectively on various devices. For example, requesting computing device 200 may broadcast request 250 to all networked devices. Responding computing devices 220 may generate a visual code 210 that uniquely identifies that responding computing device 220. The requesting computing device 200 may be pointed at a specific responding computing device 220 to sense the visual code 210 and establish the communication pairing 252 with that specific responding computing device 220. Accordingly, a user can selectively pair one or many devices with each other to establish communication pairing 252. Communication pairing 252 enables devices to communicate and access resources via a network infrastructure, without needing to enter specific network configuration information. Communication pairing 252 may involve one-to-one, one-to-many, and/or many-to-one connections between devices/resources (e.g., online media). Communication pairing 252 may use techniques associated with websockets, Zeroconf, Bonjour, ViiV, Digital Living Network Alliance (DLNA), media sharing, and other communications and/or protocols, and may enable communication between devices that may use different operating systems.

In an example scenario, the responding computing device 220 may run a framework application to determine information associated with its network presence, including an Internet Protocol (IP) address, listening port, and security information. The responding computing device 220 may run a framework application to listen for a connection request 250, encode the information into a visual datagram/visual code 210 (e.g. a QR code), and display the visual code 210 so that the requesting computing device 200 may sense it with sensor 204. The requesting computing device 200 may run a framework application to view a visual video stream or capture a series of images using sensor 204. The output of sensor 204 may be decoded to determine connection information based on the visual code 210. Requesting computing device 200 may initiate the communication pairing 252 using the determined information based on the visual code 210, and contact the responding computing device 220 to complete communication pairing 252. For example, the requesting computing device 200 may obtain network configuration information associated with the responding computing device 220, to establish network communication between the devices including password or other identify verification such as a personal identification number (PIN), cryptographic key, and the like. Thus, the framework may involve discovery and communication based on a “cloudlet” including applications on multiple devices that are to pair with each other. Components of the framework may be modular and connectable to support other mutual device discovery methods, other communication channels, and other messages. In alternate examples, the visual code 210 may be generated by the requesting computing device 200, displayed on display 206, and sensed by responding computing device 220. Communication requests and pairing may be initiated and/or established in either direction to/from either the requesting computing device 200 or the responding computing device 220. For example, a first device may determine that it lacks a camera and therefore generates the visual code 210 for a second device. A third device may determine that it lacks a display and therefore requests to sense a visual code from a fourth device.

An established communication pairing 252 may be persistent, enabling a pairing to remain valid without requiring re-pairing. Re-pairing may be enabled in situations when a network address is updated or other configuration information changes. However, devices may not need to re-pair with each use. Thus, a user may simply access the resource sharing framework through a computing device that is already paired to browse or search through an entire collection of resources without needing to specifically pair with every device each time resources are accessed.

Establishing the communication pairing 252 enables the requesting computing device 200 and the responding computing device 220 to communicate over a communication channel, such as a network connection including network connections to the Internet. The responding computing device 220 may communicate information relating to services and media available on the responding computing device 220. Thus, if the responding computing device 220 does not have a control module associated with a service/media, the requesting computing device 200 may retrieve first control module 254 from application server 240. A control module may provide both a functional specification and a “skin” for interacting with resources, such as by providing a look and feel for user interface 202 playback controls on a resource requesting device 200, and/or similar customization and functionality for a responding computing device 220. A control module may change the function, appearance, and layout of a user interface (e.g., playback and media control buttons), and may optimize a user interface for a specific usage scenario such as interaction with an application, website, or online service associated with a given control module. A control module may enable control over resources/content, as well as control over an application that manages resources/content.

Application server 240 may be an app store, such as an App Catalog for the Palm webOS platform, or any other app catalog for any additional operating system. The requesting computing device 200 may retrieve the first control module 254 based on an app purchase using a smartphone or tablet (i.e., purchasing through use of the requesting computing device 200). First control module 254 may be retrieved from various application servers 240, including servers located remotely on the Internet or locally on the network associated with the communication pairing 252. The requesting computing device 200 may retrieve the first control module 254 using a connection to the application server 240 that is separate from the communication pairing 252 with the responding computing device 220. For example, the requesting computing device 200 may use a WLAN access point for the communication pairing 252 with the responding computing device 220, and may use a cellular network connection with the application server 240 to retrieve the first control module 254. The responding computing device 220 similarly may access resources using different connections, including accessing an application server 240 via a cellular network. The requesting computing device 200 may transfer the first control module 254 to the responding computing device 220 via that communication pairing 252.

The first control module 254 may be operable by the responding computing device 220 to provide access, for the requesting computing device 200, to media/services on the responding computing device 220. Similarly, a second control module 256 may be operable on the requesting computing device 200 for resource interaction. Control modules may enable additional functionality and operability for the requesting computing device 200 and the responding computing device 220.

An application function pairing 258 may be established between the first control module 254 of the responding computing device 220 and the second control module 256 of the requesting computing device 200. The second control module 256 may configure a user interface 202 of the requesting computing device 200, such that the user interface 202 may receive input controls including application input 260 at the requesting computing device 200. The application function pairing 258 may pass application controls between the requesting computing device 200 and the responding computing device 220. The requesting computing device 200 and/or the responding computing device 220 may initiate the establishment of the application function pairing 258.

The application function pairing 258 enables application input 260 to be passed between the second control module 256 and the first control module 254. For example, the second control module 256 may provide application input 260 to play a video, and the input is passed to the first control module 254 to operate the responding computing device 220 and cause it to play a video and/or perform other functions and/or access other resources. The application input 260 may also instruct responding computing device 220 to transfer the video to the requesting computing device 200, such that the application function pairing 258 enables remote resource transfer as well as remote resource control.

In an example, a smartphone may serve as a requesting computing device 200, and a personal computer (PC) may serve as a responding computing device 220. The smartphone and PC may include preinstalled resource sharing framework software/services to enable the devices to detect a network and establish network connectivity. The smartphone may connect to a cellular network and/or a WLAN, and the PC may connect to a WLAN. The smartphone software may broadcast a request for PCs running the services to visually identify themselves. The PC may display a visual code and the smartphone may sense the visual code via the smartphone camera. The smartphone may also generate a visual code that is sensed by the PC (e.g., by a PC webcam), for example when the smartphone lacks a camera. The smartphone may identify the network characteristics of the PC, and establish a communication pairing with the PC based on the visual code. The smartphone may determine whether the PC includes media and/or services to be accessed, and determine whether a control module is present at the PC to enable access. If not, the smartphone may download, or instruct the PC to download, a control module from an application server and transfer the control module to the PC for operating the PC. The smartphone can download a similar control module for operating the smartphone. An application function pairing may then be established between the smartphone and the PC. For example, the smartphone may configure itself as a remote control to control media playback on the PC. Accordingly, application input collected by a user interface on the smartphone may be passed from the smartphone control module to the PC control module via the application function pairing so that the application input can be applied to the PC. Thus the PC may be controlled via the smartphone. Further, the smartphone may be controlled by the PC. For example, the roles of the two devices may be reversed in various scenarios including during the same pairing session. Multiple control modules may be paired between the smartphone and the PC, and multiple smartphones and/or PCs may be involved. Even when broadcasting-style network protocols are used, the visual pairing enables targeted pairing and bi-directional communication between devices on the network, without a need for specific configuration, permissions, computing device identification and/or selections, or network knowledge/settings. Thus, visual pairing between devices at a distance from each other (e.g., a television sitting at one end of a room and a hand-held portable device held while sitting on a couch) enhances the in-home, 10-foot media viewing experience where a user may enjoy resources across an entire sharing framework. Examples further enable usage scenarios involving collaborative media creation and consumption, interactive and collaborative gameplay, and interactive advertising such as with public kiosks or billboards based on pairing associated with a visual code.

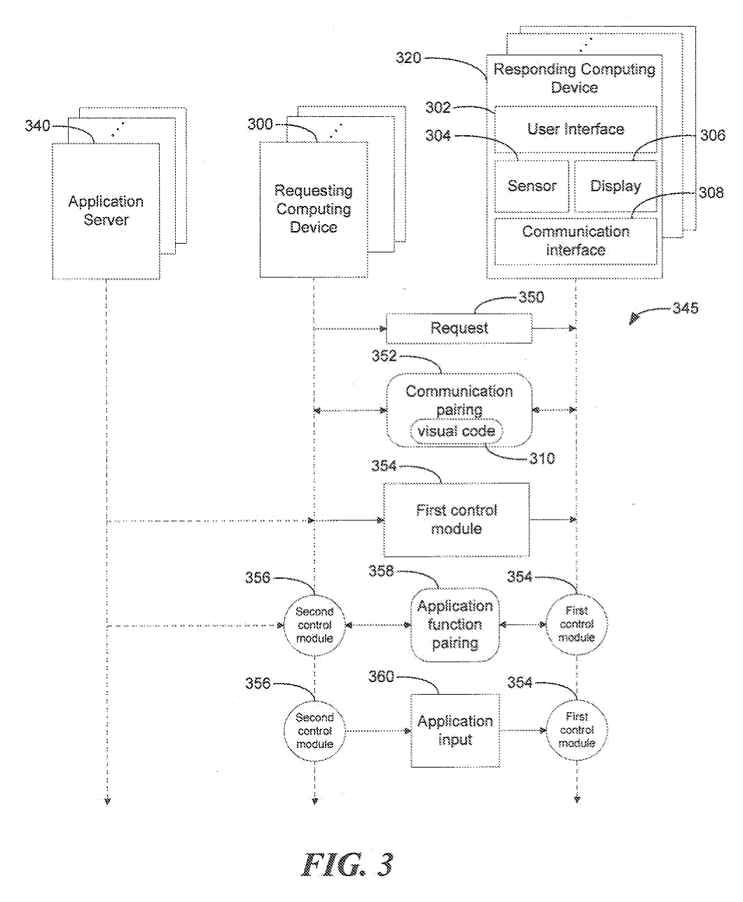

FIG. 3 is a block diagram of a responding computing device 320 according to an example. The responding computing device 320 may include a user interface 302, sensor 304, display 306, and communication interface 308, although some components (e.g., sensor 304 or display 306) may be omitted. The responding computing device 320 may pair 345 with requesting computing device 300 and receive a control module from the application server 340.

The communication interface 308 is to receive a request 350 regarding communication pairing 352. Request 350 may be initiated on the requesting computing device 300 and/or the responding computing device 320. Based on the request, the responding computing device 320 and the requesting computing device 300 exchange a visual code 310 to establish communication pairing 352. Based on the communication pairing 352, the responding computing device 320 may receive, from application server 340 via the requesting computing device 300, a first control module 354 compatible with the responding computing device 320. The responding computing device 320 may identify an existing control module present at the responding computing device 320 corresponding to the first control module 354. Accordingly, availability at the responding computing device 320 may enable application function pairing 358 without a need to download the first control module 354 from the application server 340 to the requesting computing device 300 to the responding computing device 320.

The communication interface 308 may establish an application function pairing 358 between first control module 354 and second control module 356 associated with the requesting computing device 300. The requesting computing device 300 may already include the second control module 356, or may retrieve the second control module 356 from the application server 340 if not already included with the requesting computing device 300. The application function pairing 358 may enable the responding computing device 320 to receive application input 360 provided for the first control module 354 and provided from the second control module 356, based on the application function pairing 358.

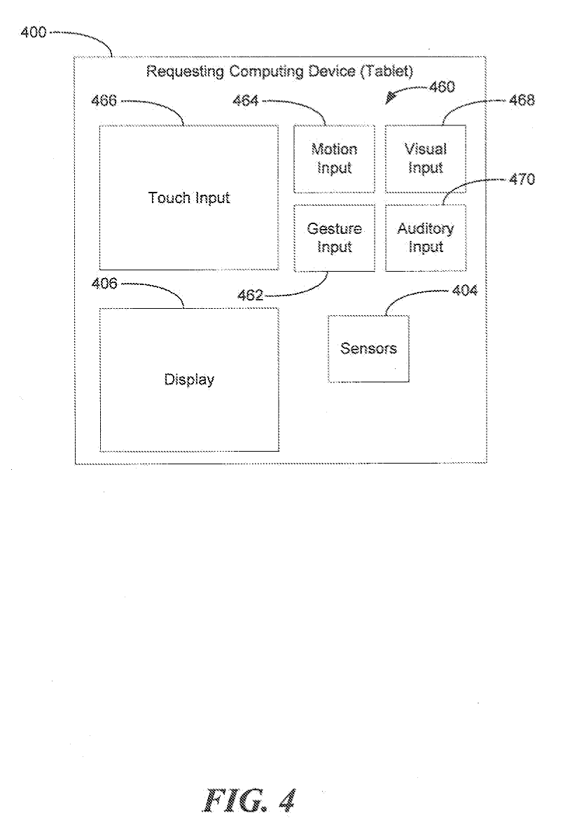

FIG. 4 is a block diagram of a requesting computing device 400 according to an example. The example shown is a tablet computing device, but other implementations such as smartphones, personal digital assistants (PDAs), netbooks, notebooks, desktop computers, and so on are possible. The requesting computing device 400 includes a display 406, touch input 466, and sensors 404.

Sensors 404 may include a camera, video sensor, light sensor, proximity sensor, accelerometer, gyroscope, compass, microphone, and other sensors. Accordingly, requesting computing device 400 may capture gesture input 462, motion input 464, touch input 466, visual input 468, and auditory input 470. Such input may be passed to a responding computing device as application input 460. Data from the responding computing device may be sent to the requesting computing device 400, including a thumbnail snapshot or live-feed of media/resources and/or a current display state of the responding computing device to be presented on display 406. Resources may be interacted with using touch input 466 or other sensors 404 to pass application input 460 to the responding computing device.

Application input 460 may be provided in various ways for various purposes. For example, a camera may capture gesture input 462 from the user, which is passed to a responding computing device 400 for further processing and use. A microphone to capture auditory input 470 may record dictation from a user, that is passed to a responding computing device for speech-to-text analysis and/or translation into user interface commands to control interactions with the responding computing device, and/or the requesting computing device 400, by passing the translated speech commands from the responding computing device to the requesting computing device 400. Accordingly, requesting computing device 400 may access computing processing capabilities of other devices, benefitting from the additional resources remotely without incurring at the requesting computing device 400 the bulk or heat associated with high processing and power capabilities so accessed.

Sensors 404 enable the requesting computing device 400 to capture a broad range of input types. Furthermore, the requesting computing device 400 may be kept at a location proximate to a user for optimal capture of application inputs. Thus, a distant responding computing device, such as a device across a room or even in another room or otherwise non-local, may be controlled by gestures or other user input that would otherwise be inaccessible by that responding computing device. Status of devices, including sensor capture, screen state, and virtual machines, may be passed between requesting and responding devices (e.g., displaying a remote desktop of the responding device on the display 406 of the requesting computing device 400.

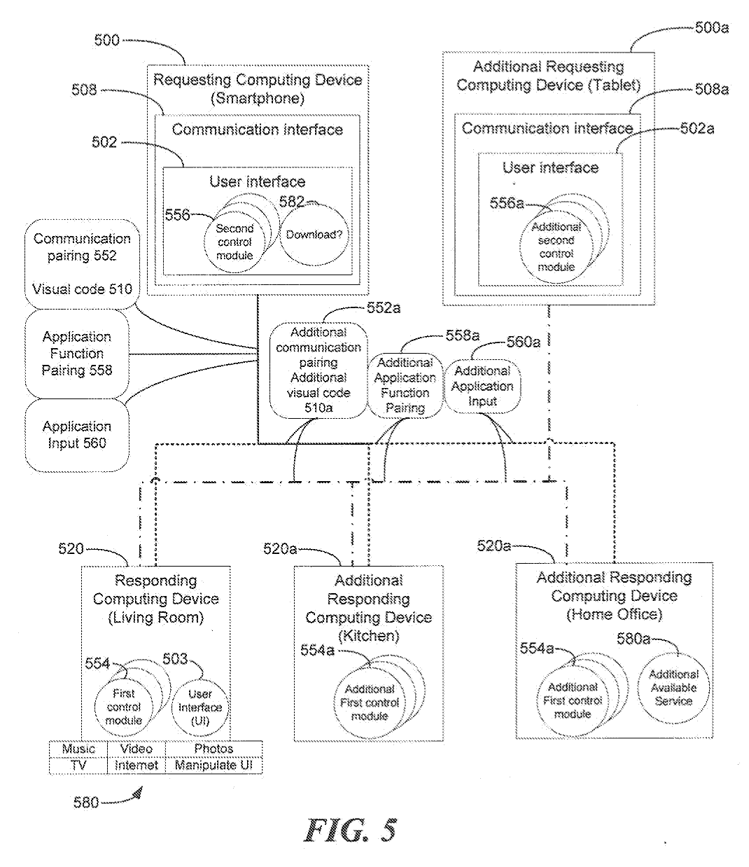

FIG. 5 is a block diagram of requesting computing devices 500, 500a and responding computing devices 520, 520a, 520b according to an example. The system of paired devices illustrate combinations of pairings including one-to-one, many-to-one, and one-to-many pairings.

Requesting computing device 500, such as a smartphone, may establish a communication pairing 552 based on a visual code 510 with responding computing device 520, such as a living room set-top box. Communication interface 508 may be used to establish the application function pairing 558 to exchange application input 560 with the responding computing device 520.

Requesting computing device 500 may pair with additional responding computing devices 520a, 520b. For example, requesting computing device 500 may establish additional communication pairing 552a based on additional visual code 510a, to establish additional application function pairing 558a to pass additional application input 560a. Thus, user interface 502 of requesting computing device 500 may pass application input 560, 560a to multiple responding computing devices 520, 520a, 520b. As an example, requesting computing device 500 may receive input to instruct responding computing devices 520, 520a, 520b to shut down remotely and simultaneously, without a user needing to visit each individual computing device to shut it down. Second control modules 556 of requesting computing device 500 may be mapped to first control modules 554, 554a, 554b of responding computing devices 520, 520a, 520b on a one-to-one, one-to-many, or many-to-one relationship.

Responding computing device 520 may be paired with requesting computing device 500 and additional requesting computing device 500a. For example, Requesting computing device 500 may include a second control module 556 associated with controlling music playback on responding computing device 520. Additional requesting computing device 500a may include an additional second control module 556a to control display of photos on responding computing device 520 (controlled via communication interface 508a and user interface 502a). Thus, computing devices 500, 500a and second control modules 556, 556a may simultaneously interact with responding computing device 520. Similar relationships may exist between any of the devices shown in FIG. 5.

The user interface 502 may provide an indication 582 of available services 580, 580b associated with a responding computing device 520, 520a, 520b, and offer to download any second control modules 556 that may be needed to access the available services 580. Thus, computing devices may discover available resources 580 and provide intuitive mechanisms for enabling interaction with those resources. Responding computing device 520 includes available services 580 such as music, video, photos, television, Internet, and manipulation of a user interface 503 associated with the responding computing device 520.

User interfaces 502, 503 may defeat a request regarding the communication pairing 552, 552a; may defeat the communication pairing 552, 552a; and may defeat the application function pairing 558, 558a. Defeating may include rejecting, delaying, canceling, ignoring, and/or otherwise preventing a request for a pairing, and/or may be applied to an established pairing. Thus, attempted or existing pairings may be prevented or temporarily defeated, with or without notification. For example, user interface 503 may provide a prompt explaining that a pairing is being attempted or is established. The user interface 503 may receive input instructing the responding computing device 520, and/or the requesting computing device(s), that the pairing/attempted pairing should be disregarded and/or abandoned. Similar prompts and control may be provided at user interface 502.

Requesting computing devices 500, 500a may pair with each other and responding computing devices 520, 520a, 520b may pair with each other. For example, additional requesting computing device 500a may serve as a responding device with respect to a pairing request issued by requesting computing device 500. Similarly, additional responding computing device 520a may serve as a requesting device with respect to issuing a pairing request. Any combination of pairings may be achieved, and roles of each member may change before, during, or after a pairing has been initiated and/or established.

Requests for pairing, including requests for visual codes, may be broadcast over the network. For example, the additional requesting computing device 500a may broadcast to the network a request for a visual code. In response, requesting computing device 500, responding computing device 520, and additional responding computing devices 520a, 520b may display a visual code. Pairing with one or more of the devices may be achieved by enabling additional requesting computing device 500a to sense the visual code displayed by the associated device. The additional requesting computing device 500a accordingly may identify and pair with selected devices based on the unique visual code generated at each device and sensed by the additional requesting computing device 500a, without requiring any network/configuration specifics to be entered separately. Devices may attempt various different pairing combinations, trading off displaying/receiving the visual codes 510, 510a between the requesting and responding devices.

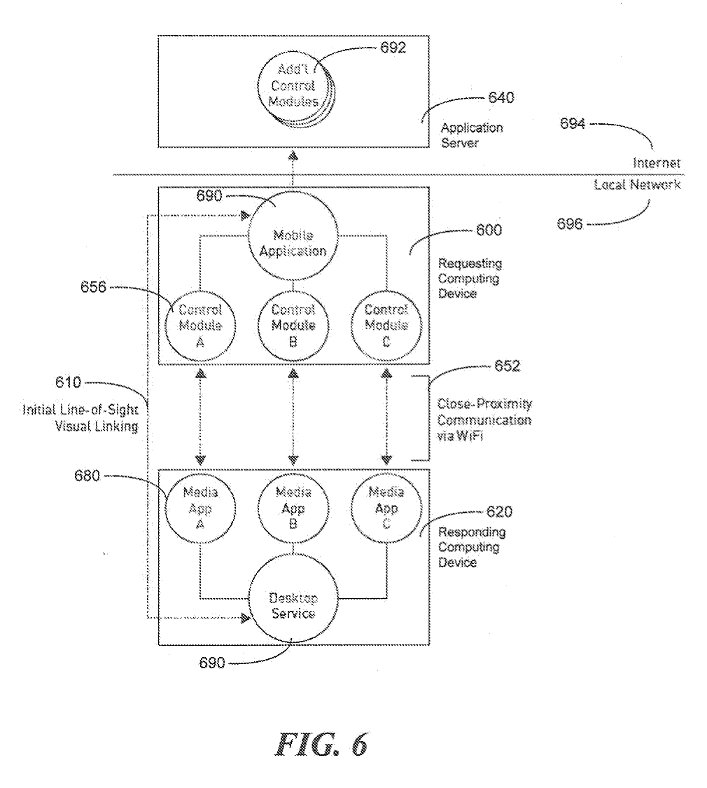

FIG. 6 is a block diagram of a requesting computing device 600 and a responding computing device 620 according to an example. Requesting computing device 600 may establish a communication pairing 652 (such as a close-proximity communication via WiFi) with responding computing device 620 via a local network 696, and the requesting computing device 600 may access additional control modules 692 on application server 640 shown accessible via the Internet 694 in the illustrated example of FIG. 6.

A visual code 610 may be used to provide initial line-of-sight visual linking for the resource sharing framework service 690 at each device, including a mobile application associated with the requesting computing device 600 and a desktop service associated with the responding computing device 620. The framework service 690 enables global framework settings, such as preferences associated with various media among the devices, to be retained independent of any specific device. Global framework settings for multiple devices may be stored on a device, shared/distributed across multiple devices, and/or stored on a remote server or cloud service. Accordingly, a user may maintain a media playlist or preferences within the framework, which may span multiple devices, locations, and media including locally stored data and cloud-based data.

The application server 640 may be accessed by the requesting computing device 600 and/or the responding computing device 620 to obtain additional control modules 692. Such modules may replace or update any of the control modules 656 or the media apps 680. Furthermore, the framework service 690, including mobile and desktop applications/services, may enable in-app transactions for retrieving and/or updating any of the modules, apps, applications, and services associated with the requesting computing device 600 and/or the responding computing device 620, and is not limited to control modules and apps.

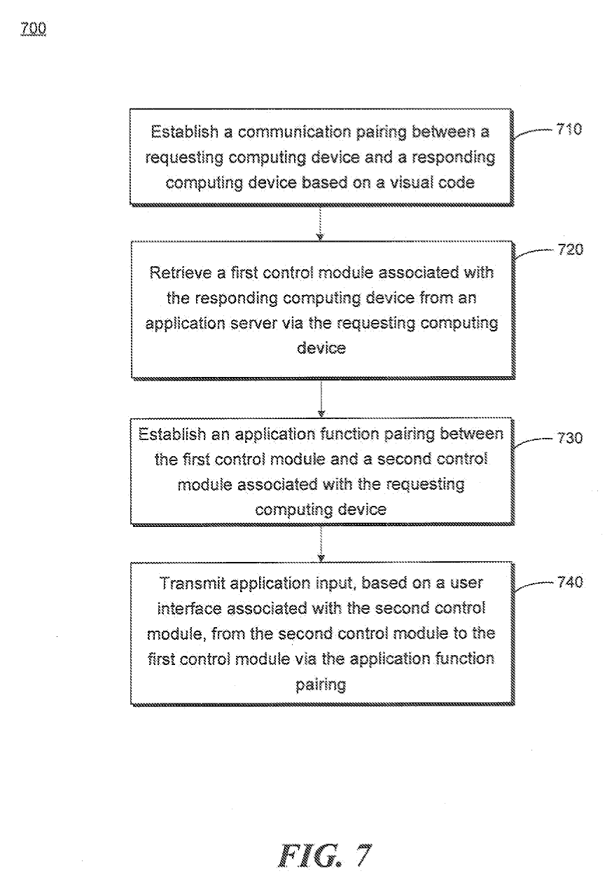

FIG. 7 is a flow chart 700 based on establishing a communication pairing between a requesting computing device and a responding computing device based on a visual code according to an example. In step 710, a communication pairing is established between a requesting computing device and a responding computing device based on a visual code. The pairing may be initiated from the requesting computing device or the responding computing device, which may prompt for input to initiate the pairing. In step 720, a first control module associated with the responding computing device is retrieved from an application server via the requesting computing device, if not available at the responding computing device. In step 730, an application function pairing is established between the first control module and a second control module associated with the requesting computing device. In step 740, application input, based on a user interface associated with the second control module, is transmitted from the second control module to the first control module via the application function pairing.

The breadth and scope of the present invention should not be limited by any of the above-described examples, but should be defined in accordance with the following claims and their equivalents.

What is claimed is:

1. A method comprising:
establishing a communication pairing between a computing device and a responding computing device based on a visual code;
retrieving a first control module associated with the responding computing device from an application server via the computing device;
establishing an application function pairing between the first control module and a second control module associated with the computing device; and
transmitting application input, based on a user interface associated with the second control module, from the second control module to the first control module via the application function pairing.

2. The method of claim 1, further comprising establishing the communication pairing based on displaying the visual code on the computing device and sensing the visual code on the responding computing device.

3. The method of claim 1, further comprising establishing the communication pairing based on displaying the visual code on the responding computing device and sensing the visual code on the computing device.

4. The method of claim 1, further comprising attempting to establish the communication pairing based on displaying the visual code on the responding computing device and sensing the visual code on the computing device, and, if the attempt is unsuccessful, requesting confirmation to establish the communication pairing based on displaying the visual code on the computing device and sensing the visual code on the responding computing device.

5. The method of claim 1, further comprising broadcasting a request for the visual code over a communication channel, wherein the request is to instruct computing devices associated with the communication channel to display a unique visual code associated with the particular computing device.

6. A computing device comprising:
a visual module associated with a visual code;
a communication interface to establish a communication pairing with a responding computing device based on the visual code, retrieve from an application server a first control module compatible with the responding computing device if not available at the responding computing device, and transmit the first control module to the responding computing device; and
a user interface to receive application input based on a second control module associated with the computing device;
wherein the communication interface is to transmit the application input from the second control module to the first control module based on an application function pairing.

7. The computing device of claim 6, wherein the visual code is a Quick Response (QR) code.

8. The computing device of claim 6, wherein the application input is based on at least one of gesture input, motion input, touch input, visual input, and auditory input.

9. The computing device of claim 6, wherein the communication interface is to establish an additional communication pairing with a corresponding additional responding computing device based on a corresponding additional visual code, and the communication interface is to transmit additional application input to a corresponding additional first control module via a corresponding additional application function pairing.

10. The computing device of claim 6, wherein the user interface is to display an indication of an available service associated with the responding computing device, and offer to download from the application server an additional control module, if not available at the computing device, associated with the available service.

11. A computer readable medium comprising instructions that if executed cause a computing device to:
establish a communication pairing with a responding computing device based on a visual code;
retrieve a first control module associated with the responding computing device from an application server;
transmit the first control module to the responding computing device;
establish an application function pairing between the first control module and a second control module associated with the computing device; and
transmit application input, based on a user interface associated with the second control module, from the second control module to the first control module via the application function pairing.

12. The computer readable medium of claim 11, further comprising instructions that if executed cause the computing device to establish an additional communication pairing with a corresponding additional responding computing device based on a corresponding additional visual code, and transmit additional application input from a corresponding additional second control module via a corresponding additional application function pairing.

13. The computer readable medium of claim 11, further comprising instructions that if executed cause the computing device to identify an additional service available at the computing device that is compatible with an additional application function pairing, wherein the visual code includes an indication of the additional service identifiable by the computing device.

14. The computer readable medium of claim 11, further comprising instructions that if executed cause the computing device to perform operations in response to the application input, including playing music, playing a video, displaying a photograph, displaying television, operating an Internet browser, and manipulating a user interface of the computing device.

15. The computer readable medium of claim 11, further comprising instructions that if executed cause the computing device to prevent establishing the communication pairing and application function pairing, and disable existing communication pairing and application function pairing, to defeat the communication pairing and the application function pairing.
